(19) United States
(12) Patent Application Publication
(10) Pub. No.: US 2002/0163264 A1
(43) Pub. Date: Nov. 7, 2002

(54) Miniature vibration motor structure

(75) Inventors: Alex Horng, Kaohsiung (TW); Ching-Shen Hong, Kaohsiung (TW); Tso-Kuo Yin, Kaohsiung Hsien (TW)

Correspondence Address: Bacon & Thomas, 625 Slaters Lane - 4th Floor, Alexandria, VA, 22314, US

(73) Assignee: Sunonwealth Electric Machine Industry Co., Ltd., Kaohsiung (TW)

(21) Appl. No.: 09/848,314

(22) Filed: May 4, 2001

(51) Int. Cl. H02K 7/06

(52) U.S. Cl. 310/81; 310/68 R; 310/156.12

(57) ABSTRACT

A miniature vibration motor structure includes an upper plate and a lower plate each having a seat hole for receiving each of two ends of a shaft column in a non-tight fit manner. The shaft column passes through the shaft hole of the bearing of the rotor in a loose fit manner. The annular permanent magnet is integrally formed on an outer periphery of the bearing. Thus, when the rotor is rotated, the center of gravity and the center of rotation of the rotor are not at the same central line. The stator seat wound with a coil has poles which may be induced with the permanent magnet of the rotor, so as to drive the rotor to rotate.

### BACKGROUND OF THE INVENTION

1. Field of the Invention

The present invention relates to a miniature vibration motor structure, and more particularly to a miniature vibration motor structure that is easily manufactured, and has a better vibration effect.

2. Description of the Related Art

A conventional miniature vibration motor structure in accordance with the prior art shown in FIG. 1 comprises an upper casing 90 and a lower casing 91 secured with each other. The upper casing 90 is provided with a seat 92 protruding upward, and the lower casing 91 is also provided with a seat 92 protruding downward. A bearing 93 is received in the seat 92. A central shaft 94 is pivoted with the upper and lower bearings 93. The central shaft 94 is fitted with a counterweight 95 that is combined with a rotor 96. The outer periphery of the rotor 96 has a permanent magnet 97 induced with a coil seat 98. The counterweight 95 of the rotor 96 is partially recessed to form a recess 99, so that vibration is generated during rotation of the rotor 96.

The conventional miniature vibration motor is usually available in the communication equipment, such as a calling machine, a mobile telephone (or cellular phone) or the like. The design of the communication equipment is required strictly to be light, thin, and small. However, in the construction of such a kind of conventional miniature vibration motor, the upper casing 90 is provided with a seat 92 protruding upward, and the lower casing 91 is also provided with a seat 92 protruding downward for receiving the bearing 93, while the outer side of the central shaft 94 is fitted with the casing. Thus, the conventional miniature vibration motor has multiple parts, thereby causing inconvenience in assembly and fabrication, and relatively, the thickness and volume thereof cannot be reduced easily. In addition, in the conventional vibration motor, the rotor 96 has a counterweight 95, thereby forming a radial vibration. Thus, the vibration effect is limited and is not apparent.

### SUMMARY OF THE INVENTION

The primary objective of the present invention is to provide an improved miniature vibration motor structure wherein the miniature vibration motor has a simpler construction, is easily assembled, and has a smaller volume and thickness.

A secondary objective of the present invention is to provide an improved miniature vibration motor structure wherein the miniature vibration motor has a better radial and axial vibration effect.

In accordance with the present invention, there is provided a miniature vibration motor structure includes an upper plate and a lower plate each having a seat hole for receiving each of two ends of a shaft column in a non-tight fit manner. The shaft column passes through the shaft hole of the bearing of the rotor in a loose fit manner. The annular permanent magnet is integrally formed on an outer periphery of the bearing. Thus, when the rotor is rotated, the center of gravity and the center of rotation of the rotor are not at the same central line. The stator seat wound with a coil has poles which may be induced with the permanent magnet of the rotor, so as to drive the rotor to rotate.

Further benefits and advantages of the present invention will become apparent after a careful reading of the detailed description with appropriate reference to the accompanying drawings.

### BRIEF DESCRIPTION OF THE DRAWINGS

FIG. 1 is a cross-sectional assembly view of a conventional miniature vibration motor structure in accordance with the prior art;

FIG. 2 is an exploded perspective view of a miniature vibration motor structure in accordance with a first embodiment of the present invention;

FIG. 3 is a cross-sectional assembly view of the miniature vibration motor structure as shown in FIG. 2;

FIG. 4 is a locally enlarged view of the miniature vibration motor structure of portion 4 as shown in FIG. 3;

FIG. 5 is a locally enlarged view of the miniature vibration motor structure of portion 5 as shown in FIG. 3;

FIG. 6 is an exploded perspective view of a miniature vibration motor structure in accordance with a second embodiment of the present invention; and

FIG. 7 is a cross-sectional assembly view of the miniature vibration motor structure as shown in FIG. 6.

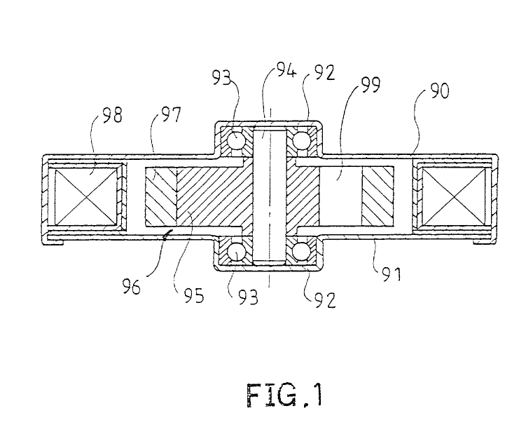

### DETAILED DESCRIPTION OF THE PREFERRED EMBODIMENTS

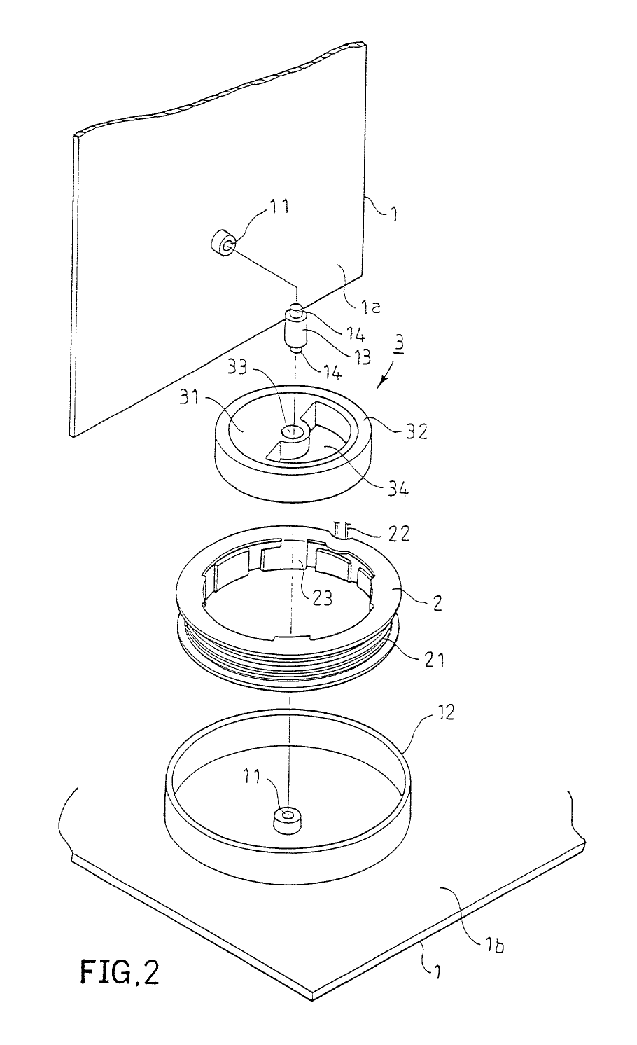

Referring to the drawings and initially to FIG. 2, a miniature vibration motor structure in accordance with a first embodiment of the present invention comprises a housing 1, a stator seat 2, and a rotor 3. The housing consists of an upper plate 1a and a lower plate 1b each having a seat hole 11 for receiving each of two ends of a shaft column 3. In the preferred embodiment, each end of the shaft column 13 may be formed with a reduced diameter portion 14 which is non-tightly inserted into the seat hole 11. The lower plate 1b may be a fixing plate such as a circuit board or a base plate. An annular wall is combined between the upper plate 1a and the lower plate 1b, for receiving the stator seat 2, so that the stator seat 2 is covered and protected.

The stator seat 2 is wound with a coil 21, and has a power inlet 22 for supplying the electric power into the stator seat 2. The stator seat 2 has poles 23 which may be induced with the permanent magnet 32 of the rotor 3, to drive the rotor 3 to rotate.

The rotor 3 includes a bearing 31, and an annular permanent magnet 32 integrally formed on the outer periphery of the bearing 31. The center of the bearing 31 of the rotor 3 has a shaft hole 33 for passage of the shaft column 13. The bearing 31 is loosely fitted with the shaft column 13, so that the bearing 31 of the rotor 3 may be rotated on the shaft column 13. The permanent magnet 32 of the rotor 3 is induced with the poles 23 of the stator seat 2, so that the rotor 3 can be driven to rotate. In the preferred embodiment, the center of gravity and the center of rotation of the rotor 3 are not at the same central line. The bearing 31 or the annular permanent magnet 32 may be provided with a recess, a protruding block, or embedded with an insert having different material and specific gravity. As shown in the figure, in the preferred embodiment, the rotor 3 is provided with a recess 34. Thus, the rotation of the rotor 3 will form an unbalanced vibration.

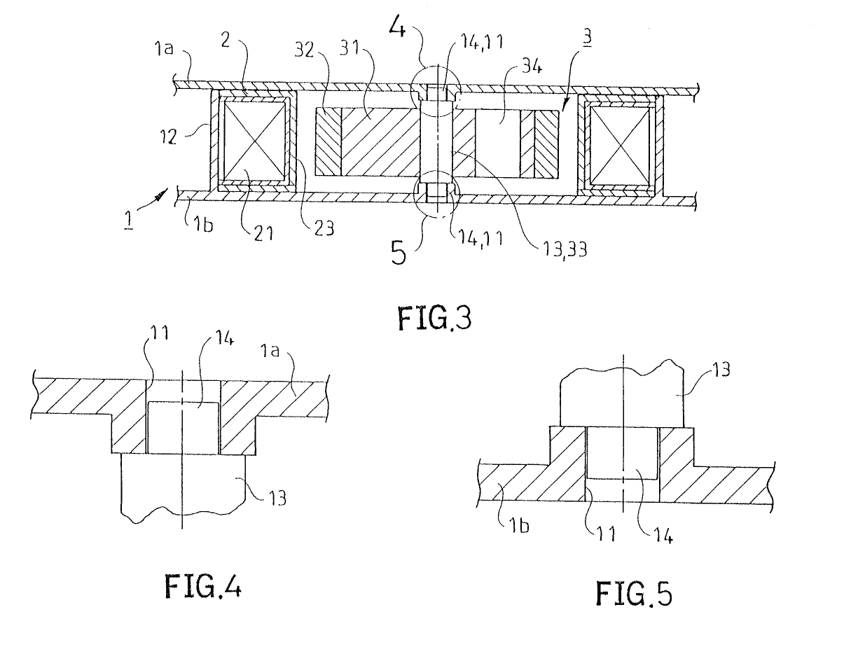

Referring to FIGS. 3-5, the miniature vibration motor structure in accordance with the first embodiment of the present invention is assembled. The reduced diameter portion 14 of each of the two ends of the shaft column 3 is directly inserted into the seat hole 11 of the upper plate 1a and the lower plate 1b of the housing 1. The reduced diameter portion 14 of the shaft column 3 and the seat hole 11 are non-tightly combined with each other. The bearing 31 of the rotor 3 is fitted on the outer wall of the shaft column 13, while the bearing 31 of the rotor 3 and the outer wall of the shaft column 13 are non-tightly combined with each other. Thus, when the rotor 3 id rotated, the permanent magnet 32 of the rotor 3 is induced with the poles 23 of the stator seat 2, so that the bearing 31 and the permanent magnet 32 are rotated relative to the shaft column 13. The center of gravity and the center of rotation of the rotor 3 are not at the same central line. Thus, the rotation of the rotor 3 will form an unbalanced vibration. In addition, the bearing 31 and the shaft column 13 are non-tightly fitted with each other, while the shaft column 13 and the seat hole 11 of the upper plate 1 a and the lower plate 1b of the housing 1 are also non-tightly fitted with each other. Thus, the rotation of the rotor 3 may form an unbalanced vibration with an eccentric rotation, and the rotor 3 may also form axial upward and downward vibration along the shaft column 13, so that the miniature vibration motor structure in accordance with the present invention will have a better vibration effect.

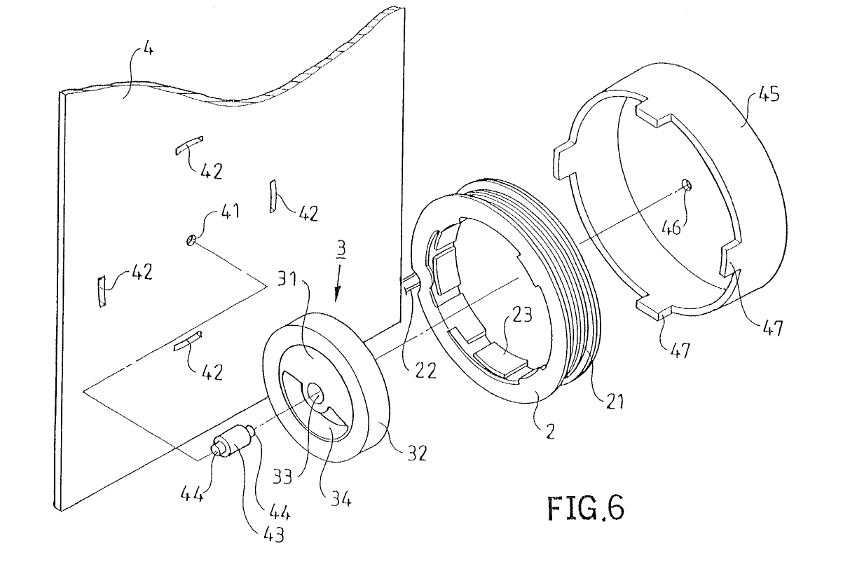

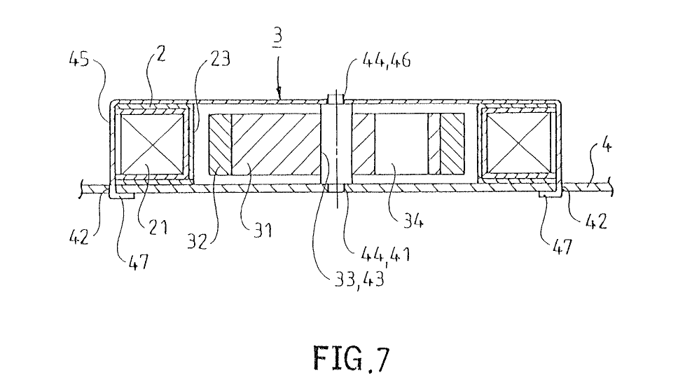

Referring to FIGS. 6 and 7, in accordance with a second embodiment of the present invention, a fixing plate 4 formed by a circuit board, a base plate or the like is provided with a shaft connecting hole 41, and a plurality of positioning holes 42. The shaft connecting hole 41 of the fixing plate 4 may allow insertion of the reduced diameter portion 44 of one end of the shaft column 43, and the reduced diameter portion 44 of the other end of the shaft column 43 is inserted into the shaft connecting hole 46 of a housing 45. The housing 45 is provided with a plurality of locking blocks 47 locked in the positioning holes 42 of the fixing plate 4. Thus, the shaft connecting hole 41 of the fixing plate 4 and the shaft connecting hole 46 of the housing 45 may allow insertion of the reduced diameter portion 44 of each of the two ends the of the shaft column 43 in a non-tight fit manner. The shaft column 43 passes through the shaft hole 33 of the bearing 31 of the rotor 3.

The rotor 3 includes a bearing 31, and an annular permanent magnet 32 integrally formed on the outer periphery of the bearing 31. The bearing 31 or the annular permanent magnet 32 may be provided with a recess 34, a protruding block, or an insert having different material and specific gravity may be embedded in the recess 34. Thus, the center of gravity and the center of rotation of the rotor 3 are not at the same central line. Therefore, when the permanent magnet 32 of the rotor 3 is induced with the poles 23 of the stator seat 2 to drive the rotor 3 to rotate, the rotation of the rotor 3 will form an unbalanced vibration. Thus, the center of gravity and the center of rotation of the rotor 3 are not at the same central line, so that the rotation of the rotor 3 may form an unbalanced vibration with an eccentric rotation, and the rotor 3 may also form an axial vibration along the shaft column 43.

Accordingly, in the improved miniature vibration motor structure in accordance with the present invention, the bearing of the rotor is rotated relative to the shaft column, and the reduced diameter portion 44 of each of the two ends the of the shaft column 43 is combined with the seat hole or the shaft connecting hole in a non-tight fit manner. Thus, when the rotor is rotated, the center of gravity and the center of rotation of the rotor 3 are not at the same central line, so that rotation of the rotor 3 may form an unbalanced vibration with an eccentric rotation, and the rotor 3 may also form axial vibration along the shaft column. Thus, the miniature vibration motor structure in accordance with the present invention will have a better vibration effect. In addition, in the miniature vibration motor structure in accordance with the present invention, the reduced diameter portion 44 of each of the two ends the of the shaft column 43 is inserted into the seat hole or the shaft connecting hole in a non-tight fit manner. Therefore, the miniature vibration motor structure in accordance with the present invention is easily assembled and manufactured.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A miniature vibration motor structure, comprising:
a housing, including an upper plate and a lower plate each having a seat hole for receiving each of two ends of a shaft column in a non-tight fit manner;
a rotor, including a bearing, and an annular permanent magnet integrally formed on an outer periphery of the bearing, the bearing having a center defining a shaft hole for passage of the shaft column, a center of gravity and a center of rotation of the rotor are not in concert with each other;
a stator seat, wound with a coil, and having a power inlet for supplying an electric power into the stator seat, the stator seat having poles which may be induced with the permanent magnet of the rotor.

2. The miniature vibration motor structure as claimed in claim 1, wherein the upper plate of the housing is a circuit board.

3. The miniature vibration motor structure as claimed in claim 1, wherein the lower plate of the housing is a circuit board.

4. The miniature vibration motor structure as claimed in claim 1, wherein the bearing or the annular permanent magnet of the rotor is provided with a recess, a protruding block, or an insert having different material and specific gravity is embedded in the recess.

5. A miniature vibration motor structure, comprising:
a fixing plate, having a shaft connecting hole, and a plurality of positioning holes, the shaft connecting hole of the fixing plate allowing non-tight combination of one end of the shaft column, a housing provided with a plurality of locking blocks locked in the positioning holes of the fixing plate, the housing having a shaft connecting hole allowing non-tight combination of the other end of the shaft column;
a rotor, including a bearing, and an annular permanent magnet integrally formed on an outer periphery of the bearing, the bearing having a center defining a shaft hole for passage of the shaft column, a center of gravity and a center of rotation of the rotor are not in concert with each other;
a stator seat, wound with a coil, and having a power inlet for supplying an electric power into the stator seat, the stator seat having poles which may be induced with the permanent magnet of the rotor.

6. The miniature vibration motor structure as claimed in claim 5, wherein the bearing or the annular permanent magnet of the rotor is provided with a recess, a protruding block, or an insert having different material and specific gravity is embedded in the recess.

7. The miniature vibration motor structure as claimed in claim 5, wherein the fixing plate may be a circuit board.
